(19) United States
(12) Patent Application Publication
(10) Pub. No.: US 2026/0329421 A1
(43) Pub. Date: Oct. 22, 2026

(54) METHOD FOR ADJUSTING VIEWING PICTURE IN VIRTUAL ENVIRONMENT, AND STORAGE MEDIUM AND DEVICE

(71) Applicant: Beijing Zitiao Network Technology Co., Ltd., Beijing (CN)

(72) Inventors: Na PANG, Beijing (CN); Yiping YANG, Beijing (CN); Chi FANG, Beijing (CN)

(21) Appl. No.: 19/113,861

(22) PCT Filed: Aug. 31, 2023
(86) PCT No.: PCT/CN2023/116228

§ 371 Date: Mar. 20, 2025

(30) Foreign Application Priority Data
Sep. 20, 2022 (CN) 202211146244.1

(51) Int. Cl. G06F 3/04845; G06F 3/01; G06F 3/04812; G06F 3/04815; G06F 3/0488; G06F 3/16

(52) U.S. Cl. CPC G06F 3/04845; G06F 3/016; G06F 3/04812; G06F 3/04815; G06F 3/0488; G06F 3/167

(57) ABSTRACT

A method for adjusting a viewing picture in a virtual environment, a storage medium, and a device are provided. The method includes: displaying a virtual environment, wherein a ray cursor and a video viewing area are presented in the virtual environment, the ray cursor points in a direction of the video viewing area, and a first included angle is formed between the ray cursor and the video viewing area; dragging the video viewing area in response to dragging control information and based on an initial position of the ray cursor and the first included angle; and determining a video picture displayed in the video viewing area based on a current dragging position of the video viewing area in the virtual environment.

The present application claims priority to Chinese Patent Application No. 202211146244.1, filed on Sep. 20, 2022, which is incorporated herein by reference in its entirety as a part of the present application.

### TECHNICAL FIELD

Embodiments of the present disclosure relate to a method and apparatus for adjusting a viewing picture and in a virtual environment, a storage medium, and a device.

### BACKGROUND

Currently, in viewing modes such as 2D video, VR180 video, and VR360 video, video pictures are displayed in a fixed frame at a fixed position, which cannot well reflect an immersive viewing experience in a virtual reality space, resulting in poor user experience.

### SUMMARY

Embodiments of the present disclosure provide a method for adjusting a viewing picture and apparatus in a virtual environment, a storage medium, and a device. A three-dimensional space dragging manner for a 2D video, a VR180 video, and a VR360 video is designed, which can allow users to experience the charm of a VR space and different viewing angles in the video field, and improve an immersive viewing experience in the virtual reality space.

In an aspect, an embodiment of the present disclosure provides a method for adjusting a viewing picture in a virtual environment, and the method includes:
displaying a virtual environment, where a ray cursor and a video viewing area are presented in the virtual environment, the ray cursor points in a direction of the video viewing area, and a first included angle is formed between the ray cursor and the video viewing area;
dragging the video viewing area in response to dragging control information and based on an initial position of the ray cursor and the first included angle; and
determining a video picture displayed in the video viewing area based on a current dragging position of the video viewing area in the virtual environment.

In some embodiments, the dragging the video viewing area in response to dragging control information and based on an initial position of the ray cursor and the first included angle includes:
dragging the video viewing area along a spherical surface of a spherical space in response to the dragging control information, with an initial position of the ray cursor being used as an origin of the spherical space, and the first included angle being fixed.

In some embodiments, when a viewing mode of the virtual environment is a two-dimensional video viewing mode, the video viewing area is a virtual screen, and the virtual screen is in a display state before the dragging control information is responded to; and
the dragging the video viewing area along a spherical surface of a spherical space includes:
dragging the virtual screen along the spherical surface of the spherical space in at least one of an x-axis direction and a y-axis direction.

In some embodiments, the method further includes:
when the virtual screen is dragged along the spherical surface of the spherical space in the y-axis direction to a top or a bottom of the y-axis direction, controlling the virtual screen to flip by 180 degrees around a center of the virtual screen.

In some embodiments, the method further includes:
when the virtual screen is dragged along the spherical surface of the spherical space to a virtual ground in the virtual environment, and the virtual screen penetrates the virtual ground, hiding the virtual ground.

In some embodiments, the method further includes:
controlling, during a dragging process, a frame of the virtual screen to be displayed in a highlighted manner; and
controlling, when the dragging ends, the frame of the virtual screen to return to normal display.

In some embodiments, the determining a video picture displayed in the video viewing area based on a current dragging position of the video viewing area in the virtual environment includes:
determining, based on a current dragging position of the virtual screen in the virtual environment, that the video picture displayed in the video viewing area is a full-screen two-dimensional video, where a video picture displayed on the virtual screen at the current dragging position and a video picture displayed on the virtual screen at a dragging start position are both full-screen two-dimensional videos.

In some embodiments, when the viewing mode of the virtual environment is a 180-degree or 360-degree panoramic video viewing mode, the video viewing area is a viewfinder of a preset proportion, and the viewfinder is in a hidden state before the dragging control information is responded to; and
the dragging the video viewing area along a spherical surface of a spherical space in response to dragging control information, with an initial position of the ray cursor being used as an origin of the spherical space, and the first included angle being fixed includes:
controlling the viewfinder to be displayed in the virtual environment in response to the dragging control information; and
dragging the viewfinder along the spherical surface of the spherical space in an x-axis direction, with an initial position of the ray cursor being used as an origin of the spherical space, and the first included angle being fixed.

In some embodiments, the method further includes:
controlling, during a dragging process, an area other than the viewfinder in the virtual environment to display a mask layer; and
hiding the viewfinder and the mask layer when the dragging ends.

In some embodiments, the method further includes:
stopping dragging when a distance value by which a left boundary of the viewfinder exceeds a left boundary of the 180-degree panoramic video reaches a preset distance value, and controlling the left boundary of the 180-degree panoramic video to move to the left boundary of the viewfinder in response to a resetting view control instruction; or
stopping dragging when a distance value by which a right boundary of the viewfinder and a right boundary of the 180-degree panoramic video reaches a preset distance value, and controlling the right boundary of the 180-degree panoramic video to move to the right boundary of the viewfinder in response to a resetting view control instruction.

In some embodiments, before the resetting view control instruction is responded to, the method further includes:
displaying resetting view prompt information in the viewfinder, where the resetting view prompt information is used to prompt an object to input the resetting view control instruction.

In some embodiments, the determining a video picture displayed in the video viewing area based on a current dragging position of the video viewing area in the virtual environment includes:
determining, based on a current dragging position of the viewfinder in the virtual environment, that a video picture displayed in the viewfinder is a video texture corresponding to the current dragging position in the panoramic video, where a video picture displayed on the viewfinder at the current dragging position is different from a video picture displayed on the viewfinder at a dragging start position.

In some embodiments, the method further includes: during a dragging process, hiding the ray cursor, and displaying a cursor focus of the ray cursor that is located on the video viewing area.

In some embodiments, the method further includes:
when the dragging control information is generated based on a button of an interactive device that is manipulated by an object, sending vibration prompt information to the interactive device in response to the dragging control information, where the vibration prompt information is used to instruct the interactive device to vibrate, to prompt that a dragging operation is triggered.

In some embodiments, the method further includes:
when the dragging control information is generated based on a bare-hand gesture of the object, outputting voice prompt information in response to the dragging control information, where the voice prompt information is used to prompt that the dragging operation is triggered.

In another aspect, an embodiment of the present disclosure provides a apparatus for adjusting a viewing picture in a virtual environment, where the apparatus includes: a display unit, a control unit, and a determination unit.

The display unit is configured to display a virtual environment, where a ray cursor and a video viewing area are presented in the virtual environment, the ray cursor points in a direction of the video viewing area, and a first included angle is formed between the ray cursor and the video viewing area.

The control unit is configured to drag the video viewing area in response to dragging control information and based on an initial position of the ray cursor and the first included angle.

The determination unit is configured to determine a video picture displayed in the video viewing area based on a current dragging position of the video viewing area in the virtual environment.

In another aspect, an embodiment of the present disclosure provides a computer-readable storage medium storing a computer program, where the computer program is suitable for loading by a processor to perform the method for adjusting a viewing picture in a virtual environment according to any one of the embodiments described above.

In another aspect, an embodiment of the present disclosure provides a virtual reality device. The virtual reality device includes a processor and a memory, where the memory stores a computer program, and the processor, by invoking the computer program stored in the memory, is configured to perform the method for adjusting a viewing picture in a virtual environment according to any one of the embodiments described above.

In another aspect, an embodiment of the present disclosure provides a computer program product including a computer program, where the computer program, when executed by a processor, implements the method for adjusting a viewing picture in a virtual environment according to any one of the embodiments described above.

### BRIEF DESCRIPTION OF DRAWINGS

In order to describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic flowchart of a method for adjusting a viewing picture in a virtual environment according to an embodiment of the present disclosure;

FIG. 2 is a first schematic diagram of an application scenario of a method for adjusting a viewing picture in a virtual environment according to an embodiment of the present disclosure;

FIG. 3 is a second schematic diagram of an application scenario of a method for adjusting a viewing picture in a virtual environment according to an embodiment of the present disclosure;

FIG. 4 is a third schematic diagram of an application scenario of a method for adjusting a viewing picture in a virtual environment according to an embodiment of the present disclosure;

FIG. 5 is a fourth schematic diagram of an application scenario of a method for adjusting a viewing picture in a virtual environment according to an embodiment of the present disclosure;

FIG. 6 is a fifth schematic diagram of an application scenario of a method for adjusting a viewing picture in a virtual environment according to an embodiment of the present disclosure;

FIG. 7 is a sixth schematic diagram of an application scenario of a method for adjusting a viewing picture in a virtual environment according to an embodiment of the present disclosure;

FIG. 8 is a seventh schematic diagram of an application scenario of a method for adjusting a viewing picture in a virtual environment according to an embodiment of the present disclosure;

FIG. 9 is an eighth schematic diagram of an application scenario of a method for adjusting a viewing picture in a virtual environment according to an embodiment of the present disclosure;

FIG. 10 is a ninth schematic diagram of an application scenario of a method for adjusting a viewing picture in a virtual environment according to an embodiment of the present disclosure;

FIG. 11 is a tenth schematic diagram of an application scenario of a method for adjusting a viewing picture in a virtual environment according to an embodiment of the present disclosure;

FIG. 12 is an eleventh schematic diagram of an application scenario of a method for adjusting a viewing picture in a virtual environment according to an embodiment of the present disclosure;

FIG. 13 is a twelfth schematic diagram of an application scenario of a method for adjusting a viewing picture in a virtual environment according to an embodiment of the present disclosure;

FIG. 14 is a schematic diagram of a structure of a apparatus for adjusting a viewing picture in a virtual environment according to an embodiment of the present disclosure;

FIG. 15 is a first schematic diagram of a structure of a virtual reality device according to an embodiment of the present disclosure; and

FIG. 16 is a second schematic diagram of a structure of a virtual reality device according to an embodiment of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

Embodiments of the present disclosure provide a method for adjusting a viewing picture and apparatus in a virtual environment, a computer-readable storage medium, a virtual reality device, a server, and a computer program product. Specifically, the method for adjusting a viewing picture in a virtual environment according to an embodiment of the present disclosure may be performed by the virtual reality device or by the server.

Embodiments of the present disclosure may be applied to various application scenarios such as extended reality (XR), virtual reality (VR), augmented reality (AR), and mixed reality (MR).

First, some nouns or terms that appear in the description of the embodiments of the present disclosure are explained as follows:

Extended reality (XR) is a concept including virtual reality (VR), augmented reality (AR), and mixed reality (MR), and indicates a technology for creating an environment in which a virtual world is connected to a real world, and a user can interact with the environment in real time.

Virtual reality (VR) is a technology for creating and experiencing a virtual world. A virtual environment is generated through calculation. The virtual environment is a type of multisource information (virtual reality mentioned in this specification at least includes visual perception, and may further include auditory perception, tactile perception, motion perception, and even gustatory perception, olfactory perception, etc.). A fused and interactive three-dimensional dynamic view and simulation of entity behaviors in the virtual environment are implemented, so that a user can be immersed in the simulated virtual reality environment, to implement applications in various virtual environments such as mapping, gaming, video, education, healthcare, simulation, collaborative training, sales, assisted manufacturing, maintenance, and repair.

Augmented reality (AR) is a technology for adding a virtual element to an image captured by a camera based on camera pose parameters of the camera in a real world (or a three-dimensional world, or a real world) that are calculated in real time during an image capturing process of the camera. The virtual element includes but is not limited to an image, a video, and a three-dimensional model. The objective of the AR technology is to place a virtual world on a real world on a screen for interaction.

Mixed reality (MR) is a simulated setting that integrates computer-created sensory input (for example, a virtual object) with sensory input from a physical setting or a representation thereof. In some MR settings, the computer-created sensory input can be adapted to changes in sensory input from the physical setting. In addition, some electronic systems for presenting MR settings can monitor an orientation and/or a position relative to the physical setting, so that the virtual object can interact with a real object (that is, a physical element from the physical setting or a representation thereof). For example, the system can monitor motion, so that a virtual plant appears to be stationary relative to a physical building.

Augmented virtuality (AV): An AV setting is a simulated setting in which a computer-created setting or virtual setting incorporates at least one sensory input from a physical setting. One or more sensory inputs from the physical setting may be representations of at least one feature of the physical setting. For example, a virtual object may present a color of a physical element captured by one or more imaging sensors. As another example, a virtual object may present features consistent with actual weather conditions in a physical setting, as identified via weather-related imaging sensors and/or online weather data. In another example, an augmented reality forest may have virtual trees and structures, but animals may have features accurately reproduced from images captured of physical animals.

A virtual field of view is an area in a virtual environment that a user can perceive through a lens in a virtual reality device, and is expressed using a field of view (FOV) of the virtual field of view.

A virtual reality device is a terminal that implements a virtual reality effect. The terminal is usually provided in the form of glasses, a head-mount display (HMD), or a contact lens, to implement visual perception and other forms of perception. Certainly, the form of the virtual reality device is not limited thereto, and may be further miniaturized or enlarged as required.

The virtual reality device described in the embodiments of the present disclosure may include but is not limited to the following types:

A computer-side virtual reality (PCVR) device uses a PC side to perform related calculation and data output for a virtual reality function. An externally connected PC-side virtual reality device uses data output by the PC side to implement a virtual reality effect.

A mobile virtual reality device supports the setting of a mobile terminal (such as a smart phone) in various manners (for example, a head-mount display provided with a dedicated card slot), and is connected to the mobile terminal through a wired or wireless connection. The mobile terminal performs related calculation for the virtual reality function and outputs data to the mobile virtual reality device. For example, a virtual reality video is watched through an APP of the mobile terminal.

An all-in-one virtual reality device includes a processor for performing related calculation for a virtual function, and therefore has an independent virtual reality input and output function, and does not need to be connected to a PC side or a mobile terminal, and has high freedom of use.

The following describes the types in detail. It should be noted that the description sequence of the following embodiments is not intended to limit the priority of the embodiments.

Each embodiment of the present disclosure provides a method for adjusting a viewing picture in a virtual environment. The method may be performed by a terminal or a server, or may be performed jointly by the terminal and the server. The method for adjusting a viewing picture in a virtual environment in the embodiments of the present disclosure is described by using an example in which the method is performed by a terminal (a virtual reality device).

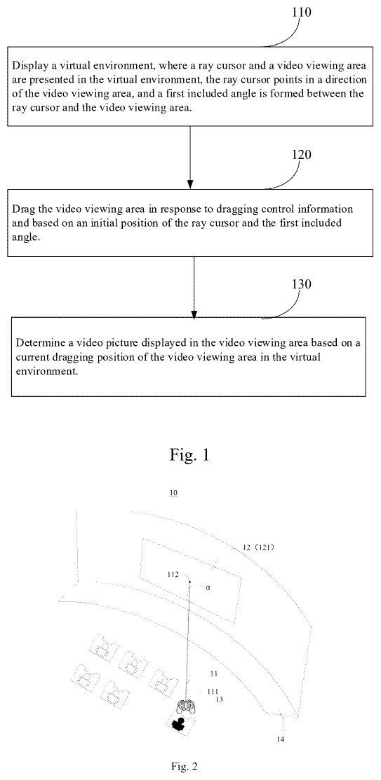

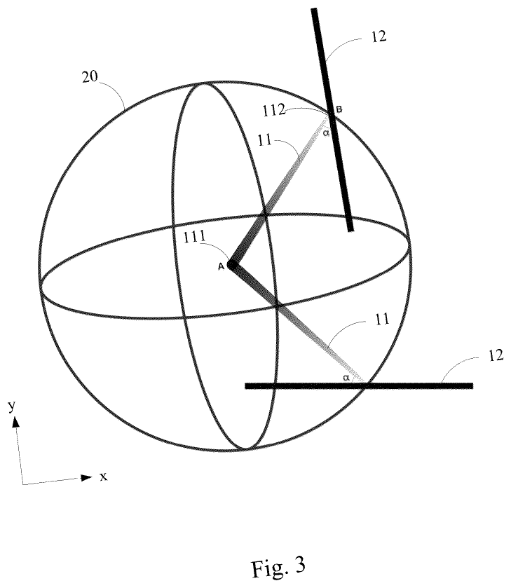

FIG. 1 to FIG. 13 are used in the following description. FIG. 1 is a schematic flowchart of a method for adjusting a viewing picture in a virtual environment according to an embodiment of the present disclosure. FIG. 2 to FIG. 13 are all schematic diagrams of related application scenarios according to an embodiment of the present disclosure. In FIG. 2, a blank background may be a three-dimensional virtual space layer. The method includes the following steps.

Step 110: Display a virtual environment, where a ray cursor and a video viewing area are presented in the virtual environment, the ray cursor points in a direction of the video viewing area, and a first included angle is formed between the ray cursor and the video viewing area.

For example, as illustrated in FIG. 2, a virtual environment 10 is displayed. A ray cursor 11 and a video viewing area 12 are presented in the virtual environment 10. The ray cursor 11 points in the direction of the video viewing area 12, and a first included angle a is formed between the ray cursor 11 and the video viewing area 12. For example, to enrich a presentation picture of the virtual environment 10, a virtual handle 13 may be presented at a start position 111 of the ray cursor 11. A front of the virtual handle 13 has the ray cursor 11 that is emitted in the direction of the video viewing area 12. The first included angle a is an included angle formed between the ray cursor 11 and a plane in which the video viewing area 12 is located.

In 2D, the viewing area is a video panel (hereinafter referred to as a virtual screen) in the specification. In VR180 and VR360, the viewing area is a visual focus area, that is, a viewfinder corresponding to subsequent dragging.

The ray cursor 11 and the video viewing area 12 that are presented in the virtual environment 10 may be normally displayed, or may be displayed in a hidden manner. For example, when a viewing mode of the virtual environment 10 is a two-dimensional video viewing mode, the video viewing area 12 may be a virtual screen. Before the virtual screen is dragged and during the dragging process, the virtual screen may be in a display state, to simulate that an object (the object may be a user) is in a viewing scene such as a cinema. Before the virtual screen is dragged, the ray cursor 11 may be in a display state, and during the dragging process, the ray cursor 11 may be in a hidden state. For example, when the virtual handle 13 is further presented at the start position 111 of the ray cursor 11, the virtual handle 13 may be in a display state before the virtual screen is dragged, and the virtual handle 13 may be in a hidden state during the dragging process. For example, when the viewing mode of the virtual environment 10 is a 180-degree or 360-degree panoramic video viewing mode, the video viewing area 12 may be a viewfinder of a preset proportion (equivalent to a visual focus area of the user in the virtual environment). Before the viewfinder is dragged, the viewfinder may be in a hidden state, to simulate that the user is in a panoramic viewing scene, and a picture of the entire virtual environment displays a panoramic video. During the dragging process, the viewfinder may be in a display state. Before the viewfinder is dragged, the ray cursor 11 may be in a display state, and during the dragging process, the ray cursor 11 may be in a hidden state. For example, when the virtual handle 13 is further presented at the start position 111 of the ray cursor 11, the virtual handle 13 may be in a display state before the viewfinder is dragged, and the virtual handle 13 may be in a hidden state during the dragging process.

Step 120: Drag the video viewing area in response to dragging control information and based on an initial position of the ray cursor and the first included angle.

For example, the dragging control information may be generated based on a button of an interactive device that is manipulated by an object. For example, the virtual environment may be displayed on a display screen of a virtual reality device. The virtual reality device may be externally connected to an interactive device. A ray cursor in the virtual environment may be driven by manipulating a button of the interactive device. In addition, a dragging operation on the video viewing area by the ray cursor may be controlled in response to the dragging control information. For example, the interactive device may include a handle, a data glove, a specific interactive apparatus, or the like.

For example, the dragging control information may be generated based on a bare-hand gesture of the object. A dragging operation on the video viewing area by the ray cursor may be controlled in response to the dragging control information.

In some embodiments, the dragging the video viewing area in response to dragging control information and based on an initial position of the ray cursor and the first included angle includes:

dragging the video viewing area along a spherical surface of a spherical space in response to the dragging control information, with an initial position of the ray cursor being used as an origin of the spherical space, and the first included angle being fixed.

For example, as illustrated in FIG. 3, a spherical space 20 may be provided. The spherical space 20 is used as a viewing container. When a viewing mode is entered, viewing may be performed in the viewing container in the spherical space 20. When the dragging control information is responded to, with an initial position 111 of the ray cursor 11 being used as an origin A of the spherical space 20, and a first included angle a between the ray cursor 11 and a plane in which the video viewing area 12 is located being fixed, the video viewing area 12 is dragged along the spherical surface of the spherical space 20. In this way, a cursor focus 112 of the ray cursor 11 is controlled to be located in the draggable video viewing area, and human-computer interaction may be performed in a spherical space in an x direction and/or a y-axis direction, to implement dragging of a viewing picture.

For example, a cubic space may alternatively be provided. The cubic space is used as a viewing container. When a viewing mode is entered, viewing may be performed in the viewing container in the cubic space. When the dragging control information is responded to, with an initial position of the ray cursor being used as a center point of the cubic space, and a first included angle between the ray cursor and a plane in which the video viewing area is located being fixed, the video viewing area is dragged along a surface of the cubic space. In this way, a cursor focus of the ray cursor is controlled to be located in the draggable video viewing area, and human-computer interaction may be performed in the cubic space in an x direction and/or a y-axis direction, to implement dragging of a viewing picture.

In some embodiments, when a viewing mode of the virtual environment is a two-dimensional video viewing mode, the video viewing area is a virtual screen, and the virtual screen is in a display state before the dragging control information is responded to; and the dragging the video viewing area along a spherical surface of a spherical space includes: dragging the virtual screen along the spherical surface of the spherical space in at least one of an x-axis direction and a y-axis direction.

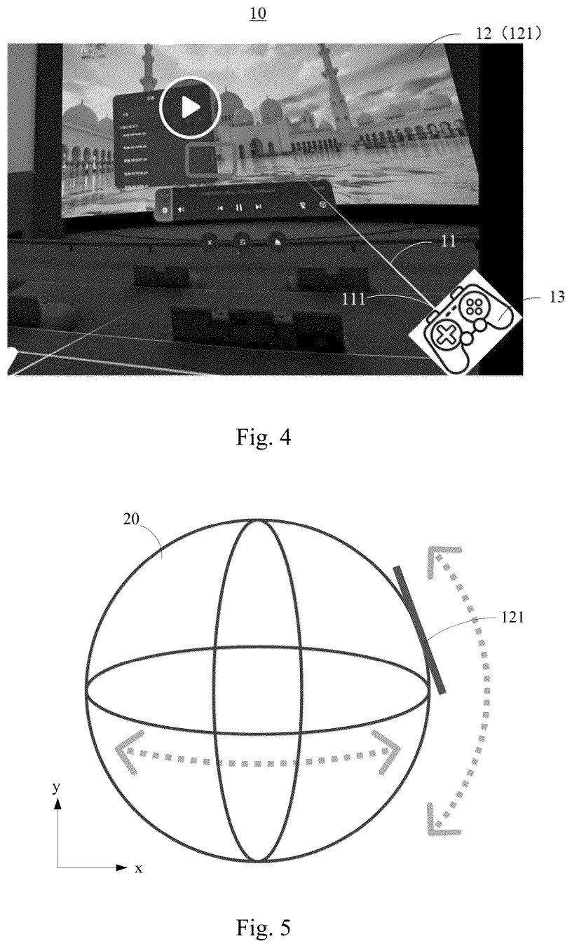

For example, when the viewing mode of the virtual environment is a two-dimensional (2D) video viewing mode, the video viewing area is a virtual screen, and the virtual screen is in a display state before the dragging control information is responded to. For example, for the 2D video viewing mode, refer to the virtual environment 10 illustrated in FIG. 2 or FIG. 4. A ray cursor 11 and a video viewing area 12 (that is, a virtual screen 121) are presented in the virtual environment 10. The ray cursor 11 points in the direction of the video viewing area 12, and a first included angle a is formed between the ray cursor 11 and the video viewing area 12. For example, to enrich a presentation picture of the virtual environment 10, a virtual handle 13 may be presented at a start position 111 of the ray cursor 11. A front of the virtual handle 13 has the ray cursor 11 that is emitted in the direction of the video viewing area 12 (that is, the virtual screen 121). The first included angle a is formed between the ray cursor 11 and the video viewing area 12 (that is, the virtual screen 121).

For example, in the 2D video viewing mode, a dragging trigger condition includes that the ray cursor 11 points to the video viewing area 12 (that is, the virtual screen 121), and the cursor focus 112 of the ray cursor 11 is located in the video viewing area 12 (that is, the virtual screen 121). The video viewing area 12 (that is, the virtual screen 121) may be understood as a video hot area range. When the object generates the dragging control information by long-pressing a preset button in an interactive device (for example, a handle), and the virtual reality device obtains the dragging control information, the virtual reality device may respond to the dragging control information to control the ray cursor 11 to have a displacement in the x/y-axis direction greater than or equal to xdp, to drag the video viewing area 12 (that is, the virtual screen 121).

For example, x in xdp is a dynamic value, and a size of a rebound may be set based on a force applied by the user during dragging. Different values may be assigned in different scenarios. dp is a density-independent pixel, and is an abstract unit based on screen density. On a display with 160 dots per inch, 1 dp=1 px.

For example, the preset button may include a grip button, a trigger button, an A/X button (with a function the same as that of the trigger button), or the like.

For example, before the dragging control information is responded to, in addition to the foregoing dragging trigger condition, an interaction avoidance condition may be further set. For example, the interaction avoidance condition includes any one of the following: Dragging is generated when a “settings panel” pops up; and dragging is generated when the “settings panel” disappears. One of the foregoing two conditions is selected for interaction avoidance, for example, it is set that dragging is generated when the “settings panel” pops up, or it is set that dragging is generated when the “settings panel” disappears.

For example, when there is a web page interaction conflict, the interaction avoidance condition may further include: When dragging is triggered, priority is given to performing “video viewing area dragging”, and “web page interaction” is not performed.

For example, in the 2D video viewing mode, when the dragging control information is responded to, a dragging object is the video viewing area 12 (that is, the virtual screen 121). A video picture displayed in the video viewing area 12 (that is, the virtual screen 121) that follows the dragged video viewing area 12 (that is, the virtual screen 121) is a 2D full-screen video. During the dragging process, the first included angle a between the ray cursor 11 and the video viewing area 12 (that is, the virtual screen 121) is fixed, and the video viewing area 12 (that is, the virtual screen 121) is dragged by moving the ray cursor 11.

As illustrated in FIG. 3, in the 2D video viewing mode, the video viewing area 12 (that is, the virtual screen 121) is spherically dragged along the spherical surface of the spherical space 20 in at least one of the x-axis direction and the y-axis direction, that is, the video viewing area 12 (that is, the virtual screen 121) moves in the x-y spherical full degree of freedom. Specifically, with an initial position 111 of the ray cursor 11 being used as an origin A of the spherical space 20, the ray cursor 11 being used as a radius of the spherical space 20, and the first included angle a between the ray cursor 11 and the video viewing area 12 (that is, the virtual screen 121) being fixed, a position (an x-axis coordinate and a y-axis coordinate) of a spherical movement landing point B is presented, that is, content seen by the object on a display screen of the virtual reality device is always a position of the point B tangent to the spherical surface of the spherical space 20, and the first included angle a is kept unchanged during dragging. For example, a line segment AB in the figure represents the ray cursor 11 emitted from the virtual handle 13 to the video viewing area 12 (that is, the virtual screen 121).

For example, during the dragging process, a RotationZ (lateral rotation) value of the video viewing area is always 0.

As illustrated in FIG. 5, during dragging, a center point of the virtual screen 121 moves along the spherical surface of the spherical space 20 in at least one of the x-axis direction and the y-axis direction.

In some embodiments, the method further includes: when the virtual screen is dragged along the spherical surface of the spherical space in the y-axis direction to a top or a bottom of the y-axis direction, controlling the virtual screen to flip by 180 degrees around a center of the virtual screen.

For example, in the 2D video viewing mode, after the y-axis direction reaches the top/bottom, the virtual screen is controlled to flip by 180 degrees. For example, an upper margin of the virtual screen is always greater than or equal to a lower margin of the virtual screen in the y-axis direction. When the dragging is performed to the upper margin of the virtual screen being equal to the lower margin of the virtual screen (the dragging is performed to the highest/lowest position), the dragging is responded to, and the virtual screen flips by 180 degrees around the center point thereof.

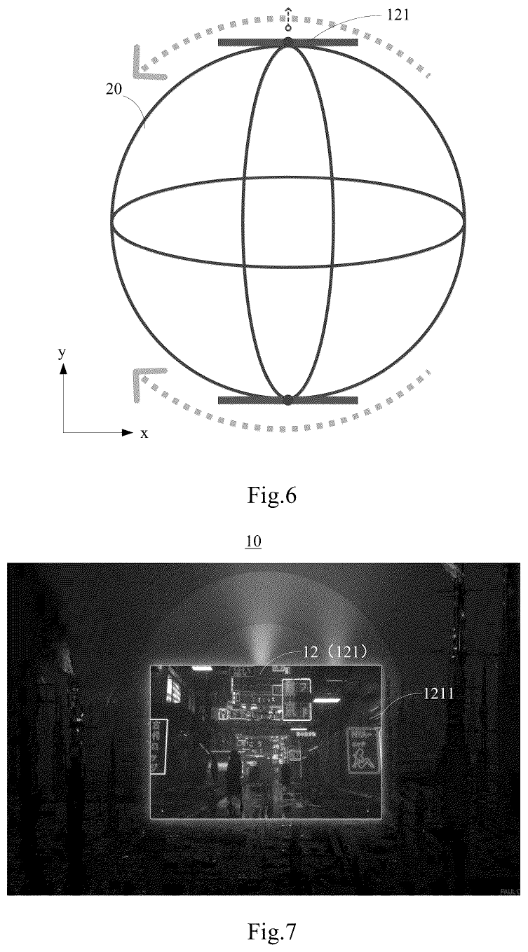

For example, as illustrated in FIG. 6, during dragging, a center point of the virtual screen 121 moves along the spherical surface of the spherical space 20 in the y-axis direction, and the center point of the virtual screen 121 is tangent to the spherical surface. During a process of continuously dragging, when the virtual screen 121 is dragged to the top or the bottom of the y-axis direction, the virtual screen 121 is controlled to flip by 180 degrees, and when the dragging operation is still ongoing, a displacement change of the dragging is responded to after the flipping.

In some embodiments, the method further includes: when the virtual screen is dragged along the spherical surface of the spherical space to a virtual ground in the virtual environment, and the virtual screen penetrates the virtual ground, hiding the virtual ground.

For example, as illustrated in FIG. 2, in the 2D video viewing mode, when dragging causes the virtual screen 121 to penetrate the virtual ground 14, the virtual ground 14 disappears, and a scene without the virtual ground 14 appears. When the virtual ground 14 disappears, a smooth dragging experience may be ensured by setting a disappearance processing condition. For example, the disappearance processing condition may be that when the virtual ground 14 is penetrated by the virtual screen 121, the virtual ground 14 gradually disappears based on a dragging speed, and when the virtual screen 121 completely passes through the virtual ground 14, the virtual ground 14 is completely hidden.

In some embodiments, the method further includes:
controlling, during a dragging process, a frame of the virtual screen to be displayed in a highlighted manner; and
controlling, when the dragging ends, the frame of the virtual screen to return to normal display.

For example, in the 2D video viewing mode, during the dragging process, as illustrated in FIG. 7, a frame 1211 of the virtual screen 121 is displayed in a highlighted manner. For example, when the dragging ends, the frame of the virtual screen returns to a normal state. For example, during the dragging process, a handle connected to the virtual reality device vibrates; and when the dragging ends, the handle stops vibrating.

For example, a resetting view instruction may be generated by long-pressing a “Home” button, to reset a view in response to the resetting view instruction, and reset a position of the virtual screen to a default position in a view.

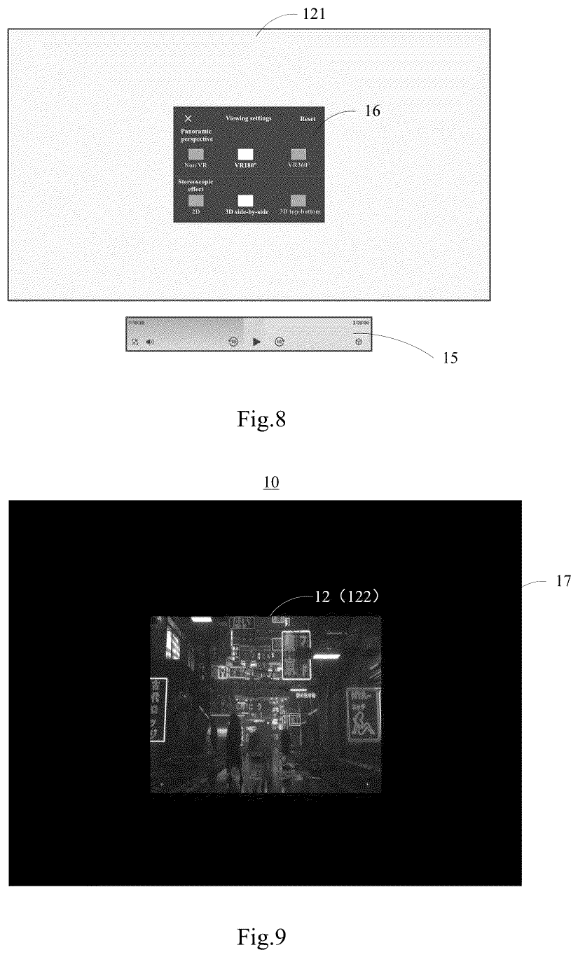

As illustrated in FIG. 8, when a playback control bar 15 and a settings panel 16 are displayed, when a cursor focus of the ray cursor is located in the virtual screen 121 and outside an area illustrated in the settings panel 16, the dragging is triggered, and the virtual screen 121 still responds to the dragging operation; and during the dragging, the playback control bar 15 and the settings panel 16 may be temporarily hidden.

In some embodiments, when a viewing mode of the virtual environment is a 180-degree or 360-degree panoramic video viewing mode, the video viewing area is a viewfinder of a preset proportion, and the viewfinder is in a hidden state before the dragging control information is responded to; and the dragging the video viewing area along a spherical surface of a spherical space in response to dragging control information, with an initial position of the ray cursor being used as an origin of the spherical space, and the first included angle being fixed includes:
controlling the viewfinder to be displayed in the virtual environment in response to the dragging control information; and
dragging the viewfinder along the spherical surface of the spherical space in an x-axis direction, with an initial position of the ray cursor being used as an origin of the spherical space, and the first included angle being fixed.

For example, when the viewing mode of the virtual environment is a 180-degree or 360-degree panoramic video viewing mode, the video viewing area is a viewfinder of a preset proportion, and the viewfinder is in a hidden state before the dragging control information is responded to. For example, the viewfinder of the preset proportion may be a 16:9 viewfinder. For example, the viewfinder may be an area of 1280*720.

For example, in the 180-degree or 360-degree panoramic video viewing mode, a dragging trigger condition includes that the ray cursor points to the video viewing area (that is, the viewfinder), and the cursor focus of the ray cursor is located in the video viewing area (that is, the viewfinder). The video viewing area (that is, the viewfinder) may be understood as a video hot area range (which may also be understood as a visual focus area in an immersive experience). When the object generates the dragging control information by long-pressing a preset button in an interactive device (for example, a handle), and the virtual reality device obtains the dragging control information, the virtual reality device may respond to the dragging control information to control the ray cursor to have a displacement in the x/y-axis direction greater than or equal to xdp, to drag the video viewing area (that is, the viewfinder).

For example, the preset button may include a grip button, a trigger button, an A/X button (with a function the same as that of the trigger button), or the like.

For example, before the dragging control information is responded to, in addition to the foregoing dragging trigger condition, an interaction avoidance condition may be further set. For example, the interaction avoidance condition includes any one of the following: Dragging is generated when a “settings panel” pops up; dragging is generated when the “settings panel” disappears; dragging is generated when the “settings panel” and an “immersion bar” disappear; dragging is generated when the “immersion bar” is displayed; and dragging is generated when the “immersion bar” disappears. One of the foregoing four conditions is selected for interaction avoidance.

For example, referring to FIG. 3, in the 180-degree or 360-degree panoramic video viewing mode, the video viewing area 12 in FIG. 3 may be a viewfinder 122. When the dragging control information is responded to, a dragging object is the video viewing area 12 (that is, the viewfinder 122). A video picture displayed in the video viewing area 12 (that is, the viewfinder 122) that follows the dragged video viewing area 12 (that is, the viewfinder 122) is a video texture corresponding to a current dragging position in a panoramic video. During the dragging process, the first included angle a between the ray cursor 11 and the video viewing area 12 (that is, the viewfinder 122) is fixed, and the video viewing area 12 (that is, the viewfinder 122) is dragged by moving the ray cursor 11.

As illustrated in FIG. 3, in the 180-degree or 360-degree panoramic video viewing mode, in a horizontal x-axis direction, with an initial position 111 of the ray cursor 11 being used as an origin A of the spherical space 20, the ray cursor 11 being used as a radius of the spherical space 20, and the first included angle a between the ray cursor 11 and the video viewing area 12 (that is, the viewfinder 122) being fixed, the video viewing area 12 (that is, the viewfinder 122) is horizontally moved and dragged along the spherical surface of the spherical space 20.

In some embodiments, the method further includes:
controlling, during a dragging process, an area in the virtual environment other than the viewfinder to display a mask layer; and
hiding the viewfinder and the mask layer when the dragging ends.

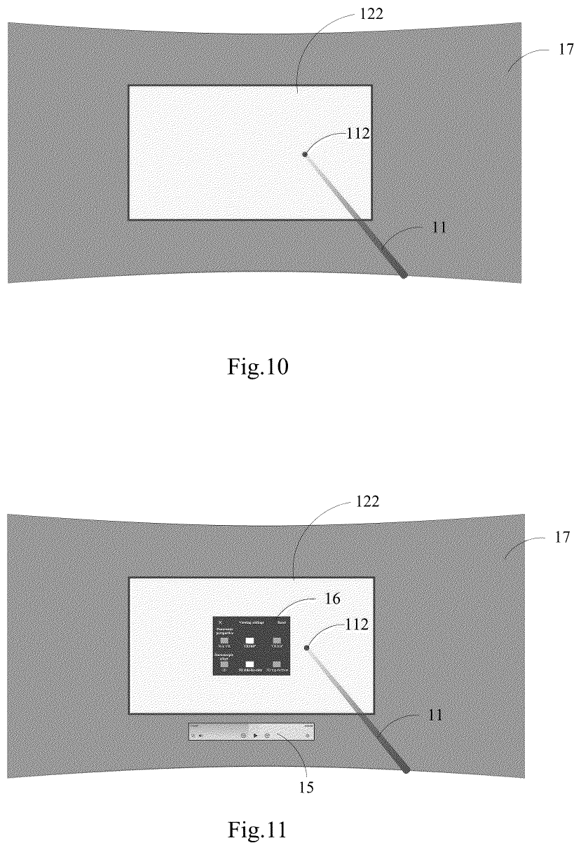

For example, as illustrated in FIG. 9 or FIG. 10, in the 180-degree or 360-degree panoramic video viewing mode, during the dragging process, an area in a virtual environment 10 other than a viewfinder 122 is controlled to display a mask layer 17. For example, the mask layer 17 may be a black mask layer, or may be a mask layer of another color. For example, during the dragging process, a video texture at a corresponding position can be seen only in the viewfinder 122, and the mask layer 17 outside the viewfinder 122 is displayed in black. When the dragging ends, the viewfinder 122 and the mask layer 17 are hidden. In the immersive experience, an immersive video picture of the entire virtual environment 10 is visible. For example, during the dragging process, a handle connected to the virtual reality device vibrates; and when the dragging ends, the handle stops vibrating.

For example, a resetting view instruction may be generated by long-pressing a “Home” button, to reset a view in response to the resetting view instruction, and reset a position of the viewfinder 122 to a default position in a view.

For example, as illustrated in FIG. 11, when a playback control bar 15 and a settings panel 16 are displayed, when a cursor focus of the ray cursor 11 is located in a viewfinder 122 and outside an area illustrated in the settings panel 16, the dragging is triggered, and the viewfinder 122 still responds to the dragging operation; and during the dragging, the playback control bar 15 and the settings panel 16 may be temporarily hidden.

In some embodiments, the method further includes:
stopping dragging when a distance value by which a left boundary of the viewfinder and a left boundary of the 180-degree panoramic video reaches a preset distance value, and controlling the left boundary of the 180-degree panoramic video to move to the left boundary of the viewfinder in response to a resetting view control instruction; or
stopping dragging when a distance value by which a right boundary of the viewfinder and a right boundary of the 180-degree panoramic video reaches a preset distance value, and controlling the right boundary of the 180-degree panoramic video to move to the right boundary of the viewfinder in response to a resetting view control instruction.

In some embodiments, before the resetting view control instruction is responded to, the method further includes:
displaying resetting view prompt information in the viewfinder, where the resetting view prompt information is used to prompt an object to input the resetting view control instruction.

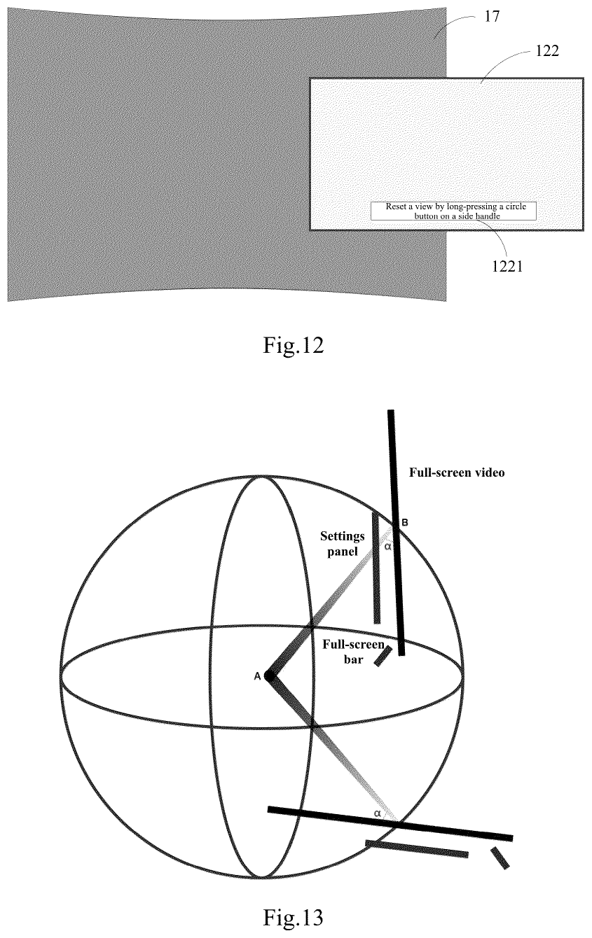

For example, as illustrated in FIG. 12, when a right boundary of a viewfinder 122 is dragged to exceed a right boundary of a panoramic video by xdp (a preset distance value), and cannot be further dragged, a video picture displayed in the viewfinder 122 is incomplete. Resetting view prompt information may be displayed in the viewfinder in a form of a toast message prompt box 1221. For example, content of the resetting view prompt information is “Reset a view by long-pressing a Home button on a side handle” or “Reset a view by long-pressing a circle button on a side handle”. The object triggers a resetting view control instruction by long-pressing the Home button or the circle button based on the content of the resetting view prompt information, so that the virtual reality device resets the view in response to the resetting view control instruction, for example, controls a left boundary of the 180-degree panoramic video to move to a left boundary of the viewfinder, or controls a right boundary of the 180-degree panoramic video to move to a right boundary of the viewfinder.

For example, the toast message prompt box 1221 is used to display a piece of resetting view prompt information in the viewfinder 122. The toast message prompt box 1221 has no control buttons, cannot obtain a focus, and automatically disappears after a period of time.

For example, a picture seen during view resetting is a picture in which a video boundary rebounds to a viewfinder boundary, that is, a left boundary of the video rebounds to the left boundary of the viewfinder, or a right boundary of the video rebounds to the right boundary of the viewfinder. If a boundary of the viewfinder is not dragged to exceed a boundary of the video, the toast message prompt box does not appear.

For example, the preset distance value is xdp. x in xdp is a dynamic value, and a size of a rebound may be set based on a force applied by the user during dragging. Different values may be assigned in different scenarios.

In some embodiments, the method further includes:
when the dragging control information is generated based on a button of an interactive device that is manipulated by an object, sending vibration prompt information to the interactive device in response to the dragging control information, where the vibration prompt information is used to indicate the interactive device to vibrate, to prompt that a dragging operation is triggered.

For example, when the interactive device is a handle, when the dragging operation is triggered, the vibration prompt information is sent to the handle. The vibration prompt information is used to indicate the handle to vibrate, and the handle generates an instantaneous vibration in response to the vibration prompt information, to prompt the object that the dragging operation is triggered. For example, a duration of the vibration is x seconds, for example, three seconds.

In some embodiments, the method further includes:
when the dragging control information is generated based on a bare-hand gesture of the object, sending voice prompt information in response to the dragging control information, where the voice prompt information is used to prompt that a dragging operation is triggered.

For example, when the dragging operation is triggered, the voice prompt information may be sent, where the voice prompt information is used to prompt that the dragging operation is triggered.

In some embodiments, the method further includes: hiding the ray cursor and displaying a cursor focus of the ray cursor located at the video viewing area during a dragging process.

For example, during the dragging process in the 2D video viewing mode, the ray cursor 11 may be hidden, and only the cursor focus 112 is displayed. Alternatively, a playback bar 15 may also be hidden; or a picture of a full-screen video may be displayed in a non-normal state; and a video playback/pause state displayed in the virtual screen 121 remains unchanged. For example, during the dragging process in the 2D video viewing mode, the displayed virtual environment is illustrated in FIG. 7, and a video picture displayed in the video viewing area 12 (that is, the virtual screen 121) is a 2D full-screen video.

For example, during the dragging process in the 180-degree or 360-degree panoramic video viewing mode, the ray cursor 11 may be hidden, and only the cursor focus 112 is displayed. A video playback/pause state displayed in the viewfinder 122 remains unchanged. For example, during the dragging process in the 180-degree or 360-degree panoramic video viewing mode, the displayed virtual environment is illustrated in FIG. 9, and a video picture displayed in the video viewing area 12 (that is, the viewfinder 122) is a video texture corresponding to the dragging position.

Step 130: Determine a video picture displayed in the video viewing area based on a current dragging position of the video viewing area in the virtual environment.

In some embodiments, when a viewing mode of the virtual environment is a two-dimensional video viewing mode, the determining a video picture displayed in the video viewing area based on a current dragging position of the video viewing area in the virtual environment includes:
determining, based on a current dragging position of a virtual screen in the virtual environment, a video picture displayed in the video viewing area as a two-dimensional video that is played in full screen, where a video picture displayed on the virtual screen at the current dragging position and a video picture displayed on the virtual screen at a dragging start position are both two-dimensional videos that are played in full screen.

For example, in the 2D video viewing mode, when the object releases the preset button that is long-pressed, a dragging end instruction is generated, so that the virtual reality device cancels the dragging in response to the dragging end instruction, and the virtual screen stays at the current dragging position. As illustrated in FIG. 13, after the dragging ends, the entire full-screen mode “UI display” of the virtual screen is used as a whole, and relative positions of a “full-screen bar”, a “full-screen video”, and a “settings panel” remain unchanged. The full-screen video is a two-dimensional video that is played in full screen.

Before, during, and after the dragging, video pictures displayed in the video viewing area in the 2D video viewing mode are all full-screen videos, and a video playback state or a video pause state remains unchanged during the dragging.

For example, in the 2D video viewing mode, after the dragging ends and the virtual environment is exited, the current dragging position is not recorded. The next time the virtual environment is entered, a display screen displays a default state. For example, the default state indicates an initial state of a display system. For example, when a user lies down to watch a movie wearing a head-mounted virtual reality device, a displayed video picture is adjusted to a tilted 45° picture (a video picture after dragging). However, when the user wears the virtual reality device next time, the displayed video picture is a normal 90° picture (the default state).

For example, position dragging information of the virtual screen may not be recorded, but scaling information of the ray cursor may be recorded. The scaling information includes a scaling size of the ray cursor. The virtual screen may be moved closer or farther away based on a center point of a screen by using the scaling size of the ray cursor.

In some embodiments, when a viewing mode of the virtual environment is a 180-degree or 360-degree panoramic video viewing mode, the determining a video picture displayed in the video viewing area based on a current dragging position of the video viewing area in the virtual environment includes:
determining, based on a current dragging position of a viewfinder in the virtual environment, a video picture displayed in the viewfinder as a video texture corresponding to the current dragging position in the panoramic video, where a video picture displayed in the viewfinder at the current dragging position is different from a video picture displayed in the viewfinder at a dragging start position.

For example, in the 180-degree or 360-degree panoramic video viewing mode, when the object releases the preset button that is long-pressed, a dragging end instruction is generated, so that the virtual reality device cancels the dragging in response to the dragging end instruction, and the viewfinder stays at the current dragging position. The viewfinder disappears in an alpha change manner, and the video picture displayed in the viewfinder is played at the current dragging position. The video picture displayed in the viewfinder is a video texture corresponding to the current dragging position in the panoramic video, where the video picture displayed in the viewfinder at the current dragging position is different from the video picture displayed in the viewfinder at the dragging start position.

For example, in an immersive viewing mode of VR180°, there is a 180° panorama, which is equivalent to one hemisphere. After the object wears the virtual reality device, a panoramic video may be watched in a 180° range. When content of a video picture displayed in the viewfinder is dragged out of a range that can be presented by 180° according to movement of the viewfinder, there is a black mask or an alpha gradient, to blend with a viewing picture. For example, a scene is in pure black, and the viewing picture is in color. When the content of the video picture is dragged out of 180°, there is a transition state from the color viewing picture to the pure black scene, and the transition state is the alpha change.

For example, in the 180-degree or 360-degree panoramic video viewing mode, after the dragging ends and the virtual environment is exited, the current dragging position is not recorded. The next time the virtual environment is entered, a display screen displays a default state.

All the foregoing technical solutions may be combined in any manner to form an optional embodiment of the present disclosure, which will not be described again one by one.

According to an embodiment of the present disclosure, a virtual environment is displayed, a ray cursor and a video viewing area are presented in the virtual environment, the ray cursor points in a direction of the video viewing area, and a first included angle is formed between the ray cursor and the video viewing area; the video viewing area is dragged in response to dragging control information and based on an initial position of the ray cursor and the first included angle; and a video picture displayed in the video viewing area is determined based on a current dragging position of the video viewing area in the virtual environment. According to the embodiment of the present disclosure, a three-dimensional space dragging manner for 2D videos, VR180 videos, and VR360 videos is designed, so that users can experience charm of a VR space and different viewing angles in a video field, thereby improving an immersive experience of watching videos in a virtual reality space.

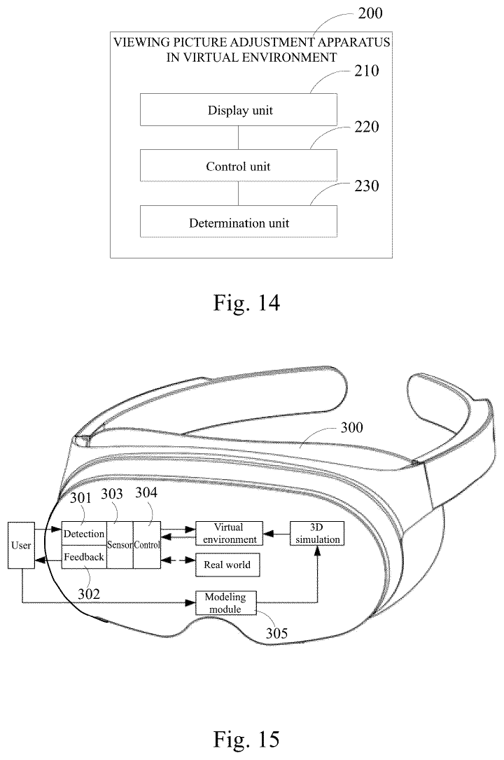

To better implement the method for adjusting a viewing picture in the virtual environment according to the embodiment of the present disclosure, an embodiment of the present disclosure further provides a apparatus for adjusting a viewing picture in a virtual environment. FIG. 14 is a schematic diagram of a structure of a apparatus for adjusting a viewing picture in a virtual environment according to an embodiment of the present disclosure. The apparatus for adjusting a viewing picture 200 in the virtual environment may include: a display unit 210, a control unit 220, and a determination unit 230.

The display unit 210is configured to display a virtual environment, where a ray cursor and a video viewing area are presented in the virtual environment, the ray cursor points in a direction of the video viewing area, and a first included angle is formed between the ray cursor and the video viewing area.

The control unit 220 is configured to drag the video viewing area in response to dragging control information and based on an initial position of the ray cursor and the first included angle.

The determination unit 230 is configured to determine a video picture displayed in the video viewing area based on a current dragging position of the video viewing area in the virtual environment.

In some embodiments, the control unit 220 is specifically configured to:
drag the video viewing area along a spherical surface of a spherical space in response to the dragging control information, with an initial position of the ray cursor being used as an origin of the spherical space, and the first included angle being fixed.

In some embodiments, when a viewing mode of the virtual environment is a two-dimensional video viewing mode, the video viewing area is a virtual screen, and the virtual screen is in a display state before the dragging control information is responded to; and
the control unit 220 is specifically configured to, when dragging the video viewing area along the spherical surface of the spherical space, drag the virtual screen along the spherical surface of the spherical space in at least one of an x-axis direction and a y-axis direction.

In some embodiments, the control unit 220 is further configured to: when the virtual screen is dragged along the spherical surface of the spherical space in the y-axis direction to a top or a bottom of the y-axis direction, control the virtual screen to flip by 180 degrees around a center of the virtual screen.

In some embodiments, the control unit 220 is further configured to: when the virtual screen is dragged along the spherical surface of the spherical space to a virtual ground in the virtual environment, and the virtual screen penetrates the virtual ground, hide the virtual ground.

In some embodiments, the control unit 220 is further configured to:
control, during a dragging process, a frame of the virtual screen to be displayed in a highlighted manner; and
control, when the dragging ends, the frame of the virtual screen to return to normal display.

In some embodiments, the determination unit 230 is specifically configured to:
determine, based on a current dragging position of a virtual screen in the virtual environment, a video picture displayed in the video viewing area as a two-dimensional video that is played in full screen, where a video picture displayed on the virtual screen at the current dragging position and a video picture displayed on the virtual screen at a dragging start position are both two-dimensional videos that are played in full screen.

In some embodiments, when a viewing mode of the virtual environment is a 180-degree or 360-degree panoramic video viewing mode, the video viewing area is a viewfinder of a preset proportion, and the viewfinder is in a hidden state before the dragging control information is responded to; and
the control unit 220 is configured to:
control the viewfinder to be displayed in the virtual environment in response to the dragging control information; and
drag the viewfinder along the spherical surface of the spherical space in an x-axis direction, with an initial position of the ray cursor being used as an origin of the spherical space, and the first included angle being fixed.

In some embodiments, the control unit 220 is further configured to:
control, during a dragging process, an area in the virtual environment other than the viewfinder to display a mask layer; and
hide the viewfinder and the mask layer when the dragging ends.

In some embodiments, the control unit 220 is further configured to:
stop dragging when a distance value by which a left boundary of the viewfinder exceeds a left boundary of the 180-degree panoramic video reaches a preset distance value, and control the left boundary of the 180-degree panoramic video to move to the left boundary of the viewfinder in response to a resetting view control instruction; or
stop dragging when a distance value by which a right boundary of the viewfinder exceeds a right boundary of the 180-degree panoramic video reaches a preset distance value, and control the right boundary of the 180-degree panoramic video to move to the right boundary of the viewfinder in response to a resetting view control instruction.

In some embodiments, before the resetting view control instruction is responded to, the control unit 220 is further configured to:
display resetting view prompt information in the viewfinder, where the resetting view prompt information is used to prompt an object to input the resetting view control instruction.

In some embodiments, the determination unit 230 is specifically configured to:
determine, based on a current dragging position of a viewfinder in the virtual environment, a video picture displayed in the viewfinder as a video texture corresponding to the current dragging position in the panoramic video, where a video picture displayed in the viewfinder at the current dragging position is different from a video picture displayed in the viewfinder at a dragging start position.

In some embodiments, the control unit 220 is further configured to: hide the ray cursor and display a cursor focus of the ray cursor located at the video viewing area during a dragging process.

In some embodiments, the control unit 220 is further configured to:
when the dragging control information is generated based on a button of an interactive device that is manipulated by an object, send vibration prompt information to the interactive device in response to the dragging control information, where the vibration prompt information is used to indicate the interactive device to vibrate, to prompt that a dragging operation is triggered.

In some embodiments, the control unit 220 is further configured to: when the dragging control information is generated based on a bare-hand gesture of the object, send voice prompt information in response to the dragging control information, where the voice prompt information is used to prompt that a dragging operation is triggered.

All or some of the units in the apparatus for adjusting a viewing picture 200 in the virtual environment may be implemented through software, hardware, or a combination thereof. The foregoing units may be embedded in a processor in the virtual reality device in a form of hardware or independently of the processor, or may be stored in a memory in the virtual reality device in a form of software, so that the processor can call and execute operations corresponding to the foregoing units.

The apparatus for adjusting a viewing picture 200 in the virtual environment may be integrated into a terminal or a server with a memory and a processor, and the terminal or the server has an operation capability, or the apparatus for adjusting a viewing picture 200 in the virtual environment is the terminal or the server.

In some embodiments, the present disclosure further provides a virtual reality device, including a memory and a processor, where a computer program is stored in the memory, and when the processor executes the computer program, the steps in the foregoing method embodiments are implemented.

As illustrated in FIG. 15, FIG. 15 is a schematic diagram of a structure of a virtual reality device according to an embodiment of the present disclosure. The virtual reality device 300 may usually be provided in a form of glasses, a head-mounted display (Head Mount Display, HMD), or contact lenses, to implement visual perception and perception in other forms. Certainly, a form implemented by the virtual reality device is not limited thereto, and may be further miniaturized or enlarged as required. The virtual reality device 300 may include but is not limited to the following components:

A detection module 301: detects an operation command of a user by using various sensors, and applies the operation command to a virtual environment, for example, an image displayed on a display screen is continuously updated according to a sight line of the user, to implement interaction between the user and a virtual and scene, for example, updated reality content is continuously updated based on a detected rotation direction of a head of the user.

A feedback module 302: receives data from the sensors, and provides real-time feedback to the user, where the feedback module 302 may be configured to display a graphical user interface, for example, display the virtual environment on the graphical user interface. For example, the feedback module 302 may include a display screen, or the like.

Sensors 303: accept the operation command from the user, and apply the operation command to the virtual environment; and on the other hand, provide a result obtained after the operation to the user in various feedback forms.

A control module 304: controls the sensors and various input/output devices, including obtaining data (such as an action and a voice) of the user and outputting perception data, such as an image, vibration, temperature, and sound, to act on the user, the virtual environment, and the real world.

A modeling module 305: constructs a three-dimensional model of the virtual environment, and may further include various feedback mechanisms such as sound and touch in the three-dimensional model.

In the embodiment of the present disclosure, the virtual environment may be constructed by using the modeling module 305, the virtual environment is displayed by using the feedback module 302, a ray cursor and a video viewing area are presented in the virtual environment, the ray cursor points in a direction of the video viewing area, and a first included angle is formed between the ray cursor and the video viewing area; then the video viewing area is dragged by using the control module 304 in response to dragging control information and based on an initial position of the ray cursor and the first included angle; and then the control module 304 determines a video picture displayed in the video viewing area based on a current dragging position of the video viewing area in the virtual environment.

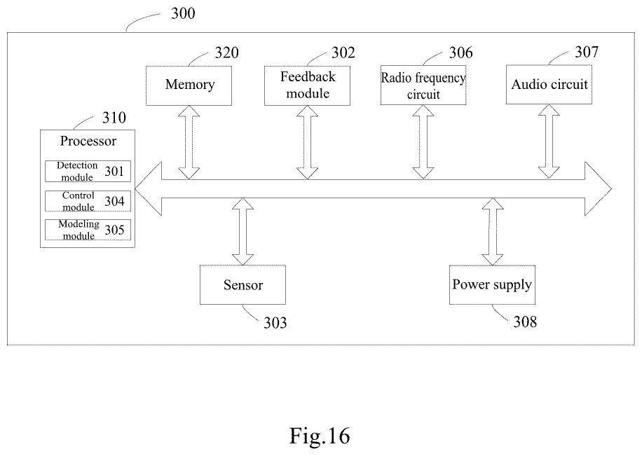

In some embodiments, as illustrated in FIG. 16, FIG. 16 is a schematic diagram of another structure of a virtual reality device according to an embodiment of the present disclosure. A virtual reality device 300 further includes a processor 310 with one or more processing cores, a memory 320 with one or more computer-readable storage mediums, and a computer program stored in the memory 320 and executable on the processor. The processor 310 is electrically connected to the memory 320. A person skilled in the art may understand that the structure of the virtual reality device illustrated in the figure does not constitute a limitation on the virtual reality device, and may include more or fewer components than those illustrated in the figure, or some components are combined, or different component arrangements.

The processor 310 is a control center of the virtual reality device 300, connects various parts of the entire virtual reality device 300 by using various interfaces and lines, executes various functions of the virtual reality device 300 and processes data by running or loading a software program and/or a module stored in the memory 320 and invoking data stored in the memory 320, thereby performing overall monitoring on the virtual reality device 300.

In the embodiment of the present disclosure, the processor 310 in the virtual reality device 300 loads an instruction corresponding to a process of one or more applications into the memory 320 according to the following steps, and runs, by the processor 310, the application program stored in the memory 320, to implement various functions:
display a virtual environment, where a ray cursor and a video viewing area are presented in the virtual environment, the ray cursor points in a direction of the video viewing area, and a first included angle is formed between the ray cursor and the video viewing area; drag the video viewing area in response to dragging control information and based on an initial position of the ray cursor and the first included angle; and determine a video picture displayed in the video viewing area based on a current dragging position of the video viewing area in the virtual environment.

For a specific implementation of each of the foregoing operations, reference may be made to the foregoing embodiments, and details are not described here again.

In some embodiments, the processor 310 may include the detection module 301, the control module 304, and the modeling module 305.

In some embodiments, as illustrated in FIG. 16, the virtual reality device 300 further includes: a radio frequency circuit 306, an audio circuit 307, and a power supply 308. The processor 310 is electrically connected to the memory 320, the feedback module 302, the sensors 303, the radio frequency circuit 306, the audio circuit 307, and the power supply 308. A person skilled in the art may understand that the structure of the virtual reality device illustrated in FIG. 15 or FIG. 16 does not constitute a limitation on the virtual reality device, and may include more or fewer components than those illustrated in the figure, or some components are combined, or different component arrangements.

The radio frequency circuit 306 may be configured to transmit and receive radio frequency signals, to establish wireless communication with a network device or another virtual reality device through wireless communication, and to send and receive signals to and from the network device or the another virtual reality device.

The audio circuit 307 may be configured to provide an audio interface between a user and the virtual reality device through a speaker and a microphone. The audio circuit 307 may convert an audio signal received and converted into an electrical signal, and transmit the electrical signal to the speaker, and the speaker converts the electrical signal into a sound signal for output. In addition, the microphone converts a collected sound signal into an electrical signal, and the audio circuit 307 receives the electrical signal, converts the electrical signal into audio data, and outputs the audio data to the processor 301 for processing, and then the radio frequency circuit 306 transmits the audio data to, for example, another virtual reality device, or outputs the audio data to the memory for further processing. The audio circuit 307 may further include an earphone jack, to provide communication between an external earphone and the virtual reality device.

The power supply 308 is configured to supply power to various components of the virtual reality device 300.

Although not illustrated in FIG. 15 or FIG. 16, the virtual reality device 300 may further include a camera, a Wi-Fi module, a Bluetooth module, an input module, and the like, which are not described in detail herein.

In some embodiments, the present disclosure further provides a computer-readable storage medium, configured to store a computer program. The computer-readable storage medium may be applied to the virtual reality device or the server, and the computer program enables the virtual reality device or the server to perform a corresponding process in the method for adjusting a viewing picture in the virtual environment in the embodiment of the present disclosure. For brevity, details are not described herein again.

In some embodiments, the present disclosure further provides a computer program product. The computer program product includes a computer program, and the computer program is stored in a computer-readable storage medium. A processor of the virtual reality device reads the computer program from the computer-readable storage medium, and the processor executes the computer program, so that the virtual reality device performs a corresponding process in the method for adjusting a viewing picture in the virtual environment in the embodiment of the present disclosure. For brevity, details are not described herein again.

The present disclosure further provides a computer program. The computer program includes a computer program, and the computer program is stored in a computer-readable storage medium. A processor of the virtual reality device reads the computer program from the computer-readable storage medium, and the processor executes the computer program, so that the virtual reality device performs a corresponding process in the method for adjusting a viewing picture in the virtual environment in the embodiment of the present disclosure. For brevity, details are not described herein again.

It should be understood that a processor in an embodiment of the present disclosure may be an integrated circuit chip and has a signal processing capability. In an implementation process, the steps of the foregoing method embodiments may be completed by an integrated logic circuit of hardware in the processor or an instruction in a form of software. The foregoing processor may be a general-purpose processor, a digital signal processor (Digital Signal Processor, DSP), an application-specific integrated circuit (Application Specific Integrated Circuit, ASIC), a field programmable gate array (Field Programmable Gate Array, FPGA) or another programmable logical device, a discrete gate or transistor logical device, or a discrete hardware component. The methods, steps, and logical block diagrams disclosed in the embodiments of the present disclosure may be implemented or executed. The general-purpose processor may be a microprocessor or the processor may be any conventional processor or the like. The steps of the method disclosed in combination with the embodiments of the present disclosure may be directly embodied as being executed and completed by a hardware decoding processor, or executed and completed by a combination of hardware and a software module in the decoding processor. The software module may be located in a mature storage medium in the art, such as a random memory, a flash memory, a read-only memory, a programmable read-only memory, an electrically erasable programmable memory, or a register. The storage medium is located in a memory, and a processor reads information in the memory, and completes the steps of the foregoing method in combination with the hardware.

It may be understood that a memory in the embodiments of the present disclosure may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which is used as an external cache. By way of example but not limitation, many forms of RAM are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that a memory of the system and method described in this specification is intended to include but is not limited to these and any other suitable types of memories.

A person of ordinary skill in the art may be aware that the units and algorithm steps of each example described in conjunction with the embodiments disclosed herein can be implemented in electronic hardware, or a combination of computer software and electronic hardware. Whether these functions are performed in hardware or software depends on a specific application and design constraint conditions of the technical solutions. A person skilled in the art may implement the described functions using different methods for each specific application, but such implementation should not be considered as going beyond the scope of the present disclosure.

It may be clearly understood by a person skilled in the art that, for the convenience and brevity of description, for a specific working process of the foregoing system, apparatus, and unit, reference may be made to a corresponding process in the foregoing method embodiments, and details are not described herein again.

In the several embodiments provided in the present disclosure, it should be understood that the disclosed system, apparatus, and method may be implemented in other manners. For example, the described apparatus embodiments are merely examples. For example, the division of the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, the functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure are essentially, or the part contributing to the prior art, or all or some of the technical solutions may be implemented in the form of a software product. The computer software product is stored in a storage medium and includes several instructions for instructing a virtual reality device (which may be a personal computer or a server) to perform all or some of the steps of the methods described in the embodiments of the present disclosure. The foregoing storage medium includes: any medium that can store program code, such as a USB flash drive, a removable hard disk, a ROM, a RAM, a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A method for adjusting a viewing picture in a virtual environment, comprising:
displaying a virtual environment, wherein a ray cursor and a video viewing area are presented in the virtual environment, the ray cursor points in a direction of the video viewing area, and a first included angle is formed between the ray cursor and the video viewing area;
dragging the video viewing area in response to dragging control information and based on an initial position of the ray cursor and the first included angle; and
determining a video picture displayed in the video viewing area based on a current dragging position of the video viewing area in the virtual environment.

2. The method for adjusting a viewing picture in the virtual environment according to claim 1, wherein the dragging the video viewing area in response to dragging control information and based on an initial position of the ray cursor and the first included angle, comprises:
dragging the video viewing area along a spherical surface of a spherical space in response to the dragging control information, with the initial position of the ray cursor being used as an origin of the spherical space and the first included angle being fixed.

3. The method for adjusting a viewing picture in the virtual environment according to claim 2, wherein when a viewing mode of the virtual environment is a two-dimensional video viewing mode, the video viewing area is a virtual screen, and the virtual screen is in a display state before the dragging control information is responded to; and
the dragging the video viewing area along the spherical surface of the spherical space comprises:
dragging the virtual screen along the spherical surface of the spherical space in at least one of an x-axis direction and a y-axis direction.

4. The method for adjusting a viewing picture in the virtual environment according to claim 3, further comprising:
when the virtual screen is dragged along the spherical surface of the spherical space in the y-axis direction to a top or a bottom of the y-axis direction, controlling the virtual screen to flip by 180 degrees around a center of the virtual screen.

5. The method for adjusting a viewing picture in the virtual environment according to claim 3, further comprising:
when the virtual screen is dragged along the spherical surface of the spherical space to a virtual ground in the virtual environment, and the virtual screen penetrates the virtual ground, hiding the virtual ground.

6. The method for adjusting a viewing picture in the virtual environment according to claim 3, further comprising:
controlling, during a dragging process, a frame of the virtual screen to be displayed in a highlighted manner; and
controlling, when the dragging ends, the frame of the virtual screen to return to normal display.

7. The method for adjusting a viewing picture in the virtual environment according to claim 3, wherein the determining a video picture displayed in the video viewing area based on a current dragging position of the video viewing area in the virtual environment comprises:
determining, based on a current dragging position of the virtual screen in the virtual environment, a video picture displayed in the video viewing area as a two-dimensional video that is played in full screen, wherein a video picture displayed on the virtual screen at the current dragging position and a video picture displayed on the virtual screen at a dragging start position are both two-dimensional videos that are played in full screen.

8. The method for adjusting a viewing picture in the virtual environment according to claim 2, wherein when a viewing mode of the virtual environment is a 180-degree or 360-degree panoramic video viewing mode, the video viewing area is a viewfinder of a preset proportion, and the viewfinder is in a hidden state before the dragging control information is responded to; and
the dragging the video viewing area along the spherical surface of the spherical space in response to the dragging control information, with an initial position of the ray cursor being used as an origin of the spherical space and the first included angle being fixed, comprises:
controlling the viewfinder to be displayed in the virtual environment in response to the dragging control information; and
dragging the viewfinder along the spherical surface of the spherical space in an x-axis direction, with the initial position of the ray cursor being used as the origin of the spherical space and the first included angle being fixed.

9. The method for adjusting a viewing picture in the virtual environment according to claim 8, further comprising:
controlling, during a dragging process, an area in the virtual environment other than the viewfinder to display a mask layer; and
hiding the viewfinder and the mask layer when the dragging ends.

10. The method for adjusting a viewing picture in the virtual environment according to claim 8, further comprising:
stopping dragging when a distance value by which a left boundary of the viewfinder exceeds a left boundary of the 180-degree panoramic video reaches a preset distance value, and controlling the left boundary of the 180-degree panoramic video to move to the left boundary of the viewfinder in response to a resetting view control instruction; or
stopping dragging when a distance value by which a right boundary of the viewfinder exceeds a right boundary of the 180-degree panoramic video reaches the preset distance value, and controlling the right boundary of the 180-degree panoramic video to move to the right boundary of the viewfinder in response to the resetting view control instruction.

11. The method for adjusting a viewing picture in the virtual environment according to claim 10, wherein before the resetting view control instruction is responded to, the method for adjusting a viewing picture in the virtual environment further comprises:
displaying resetting view prompt information in the viewfinder, wherein the resetting view prompt information is used to prompt an object to input the resetting view control instruction.

12. The method for adjusting a viewing picture in the virtual environment according to claim 8, wherein the determining a video picture displayed in the video viewing area based on a current dragging position of the video viewing area in the virtual environment, comprises:
determining, based on a current dragging position of a viewfinder in the virtual environment, a video picture displayed in the viewfinder as a video texture corresponding to the current dragging position in the panoramic video, wherein a video picture displayed in the viewfinder at the current dragging position is different from a video picture displayed in the viewfinder at a dragging start position.

13. The method for adjusting a viewing picture in the virtual environment according to claim 1, further comprising:
hiding the ray cursor and displaying a cursor focus of the ray cursor located at the video viewing area during a dragging process.

14. The method for adjusting a viewing picture in the virtual environment according to claim 1, further comprising:
when the dragging control information is generated based on a button of an interactive device that is manipulated by an object, sending vibration prompt information to the interactive device in response to the dragging control information, wherein the vibration prompt information is used to indicate the interactive device to vibrate, to prompt that a dragging operation is triggered.

15. The method for adjusting a viewing picture in the virtual environment according to claim 1, further comprising:
when the dragging control information is generated based on a bare-hand gesture of an object, sending voice prompt information in response to the dragging control information, wherein the voice prompt information is used to prompt that a dragging operation is triggered.

16. (canceled)

17. A non-transitory computer-readable storage medium, storing a computer program, wherein the computer program causes a processor, to perform a method for adjusting a viewing picture, and the method comprises:
displaying a virtual environment, wherein a ray cursor and a video viewing area are presented in the virtual environment, the ray cursor points in a direction of the video viewing area, and a first included angle is formed between the ray cursor and the video viewing area;
dragging the video viewing area in response to dragging control information and based on an initial position of the ray cursor and the first included angle; and
determining a video picture displayed in the video viewing area based on a current dragging position of the video viewing area in the virtual environment.

18. A virtual reality device, comprising a processor and a memory, wherein the memory stores a computer program, and the processor is configured to, by invoking the computer program stored in the memory, perform a method for adjusting a viewing picture in the virtual environment, and the method comprises:
displaying a virtual environment, wherein a ray cursor and a video viewing area are presented in the virtual environment, the ray cursor points in a direction of the video viewing area, and a first included angle is formed between the ray cursor and the video viewing area;
dragging the video viewing area in response to dragging control information and based on an initial position of the ray cursor and the first included angle; and
determining a video picture displayed in the video viewing area based on a current dragging position of the video viewing area in the virtual environment.

19. (canceled)

20. The non-transitory computer-readable storage medium of claim 17, wherein the dragging the video viewing area in response to dragging control information and based on an initial position of the ray cursor and the first included angle, comprises:
dragging the video viewing area along a spherical surface of a spherical space in response to the dragging control information, with the initial position of the ray cursor being used as an origin of the spherical space and the first included angle being fixed.

21. The non-transitory computer-readable storage medium of claim 20, wherein when a viewing mode of the virtual environment is a two-dimensional video viewing mode, the video viewing area is a virtual screen, and the virtual screen is in a display state before the dragging control information is responded to; and
the dragging the video viewing area along the spherical surface of the spherical space comprises:
dragging the virtual screen along the spherical surface of the spherical space in at least one of an x-axis direction and a y-axis direction.

22. The virtual reality device of claim 18, wherein the dragging the video viewing area in response to dragging control information and based on an initial position of the ray cursor and the first included angle, comprises:
dragging the video viewing area along a spherical surface of a spherical space in response to the dragging control information, with the initial position of the ray cursor being used as an origin of the spherical space and the first included angle being fixed.
